(19) United States
(12) Patent Application Publication
(10) Pub. No.: US 2012/0280040 A1
(43) Pub. Date: Nov. 8, 2012

(54) WIRELESS-BASED CHECKOUT AND LOSS PREVENTION

(75) Inventors: Mark D. Carney, Sterling, VA (US); Dante Pacella, Charles Town, WV (US); Harold J. Schiller, Silver Spring, MD (US)

(73) Assignee: VERIZON PATENT AND LICENSING INC., Basking Ridge, NJ (US)

(21) Appl. No.: 13/194,060

(22) Filed: Jul. 29, 2011

Related U.S. Application Data
(63) Continuation-in-part of application No. 13/102,516, filed on May 6, 2011.

(51) Int. Cl. G06K 15/00

(52) U.S. Cl. 235/383

(57) ABSTRACT

A method may include reading tags associated with items that are leaving a store with a person and receiving an electronic receipt associated with the person. The method may also include comparing the items that are leaving the store with information included in the electronic receipt and determining whether a discrepancy exists based on the comparing.

### RELATED APPLICATION

This application is a continuation-in-part (CIP) of U.S. patent application Ser. No. 13/102,516 filed May 6, 2011, entitled “Mobile Transaction Services,” the disclosure of which is hereby incorporated herein by reference.

### BACKGROUND INFORMATION

When exiting a store, a merchant may be concerned that a customer is leaving with more items than he/she purchased. Conversely, when a customer leaves a store, he/she is concerned with making sure that no purchased items were inadvertently left in the store. Currently, many stores place personnel near the exits to manually check the customer's receipt against products in the customer's cart as the customer leaves the store. Such checks are often performed randomly and are also prone to problems, such as being unable to check all the items in a cart, creating a choke point for customer's leaving the store, increasing costs associated with added security personnel, etc.

### BRIEF DESCRIPTION OF THE DRAWINGS

FIG. 1 illustrates an exemplary network in which systems and methods described herein may be implemented;

FIG. 2 illustrates an exemplary configuration of components implemented in one or more of the devices of FIG. 1;

FIG. 3 illustrates an exemplary configuration of logic components implemented by one of the devices of FIG. 1;

FIG. 4 illustrates an exemplary configuration of logic components implemented by another one of the devices of FIG. 1;

FIG. 5 is a flow diagram illustrating exemplary processing by various components illustrated in FIG. 1 in accordance with an exemplary implementation;

FIGS. 6A and 6B illustrate information displayed by the user device of FIG. 1 in accordance with exemplary implementations; and

FIG. 7 is a flow diagram illustrating exemplary processing associated with components of FIG. 1 in accordance with another exemplary implementation.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to providing for loss prevention by retailers and also ensuring that a customer does not leave purchased items in the retail location. In an exemplary implementation, a reader device or system may read tags or labels associated with merchandise/items exiting and entering a store. The reader device/system may also query a mobile device associated with a customer as the customer leaves the store for an electronic receipt that identifies the items purchased by the customer. The reader device/system may then compare the items leaving the store with the customer's receipt. If a discrepancy is detected, store personnel may be alerted to ensure that the customer is not leaving with an item that was not purchased and/or that the customer did not leave a purchased item in the store. In some implementations, the reader device/system may also take into consideration the items/merchandise that the customer brought into the store to determine whether any of the items exiting the store correspond to a returned/exchanged item.

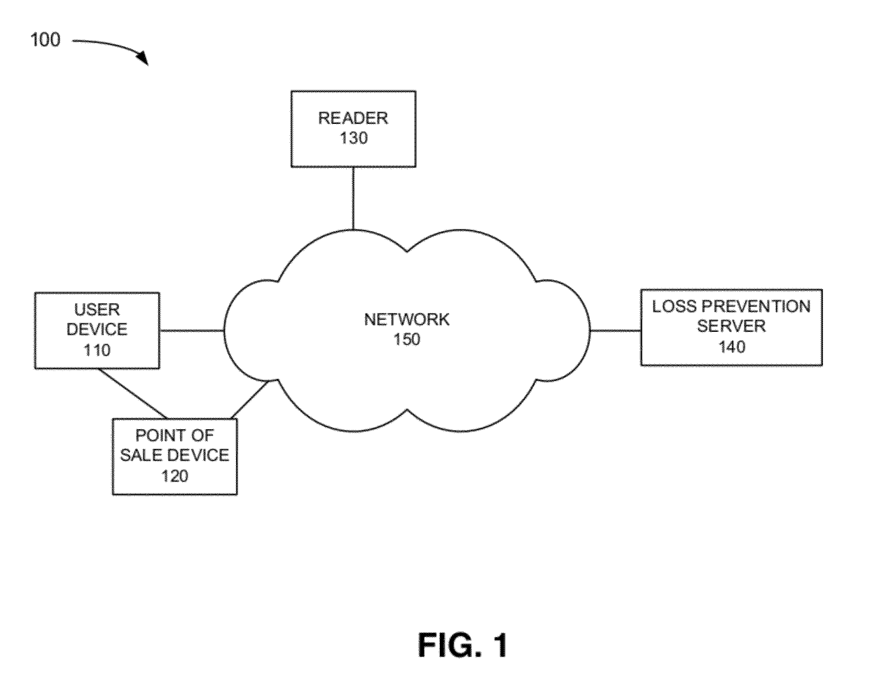

FIG. 1 is a block diagram of an exemplary network 100 in which systems and methods described herein may be implemented. Network 100 may include user device 110, point-of-sale (PoS) device 120, reader 130, loss prevention server 140 and network 150.

User device 110 may represent a device associated with a party who wishes to participate in a transaction, such as making a purchase from a retailer or vendor. For example, user device 110 may include a mobile device, such as wireless or cellular telephone device (e.g., a conventional cell phone with data processing capabilities), a smart phone, a personal digital assistant (PDA) that can include a radiotelephone, etc. In another implementation, user device 110 may include any type of mobile computer device or system, such as a personal computer (PC), a laptop, a tablet computer, a notebook, a netbook, a portable game-playing system, a portable music player, etc., that may include communication functionality. User device 110 may connect to network 150 and other devices in network 100 (e.g., PoS device 120, reader 130, loss prevention server 140) via any conventional technique, such as wired, wireless, or optical connections. User device 110 and the person associated with user device 110 (e.g., the party holding or using user device 110) may be referred to collectively as user device 110 in the description below.

PoS device 120 may represent a device/system where a purchase may be made. For example, PoS device 120 may include an electronic cash register in a retail location (e.g., store) or another device/system that is able to receive payment information and/or other information from user device 110. PoS device 120 may also include a scanner used to scan barcodes or other types of identification information.

Reader 130 may include one or more devices or systems used to read tags included in merchandise. For example, reader 130 may include a radio frequency identification (RFID) system/interface that is able to read an RFID tag or label included with purchased merchandise. In this case, reader 130 may wirelessly read a tag or label included with purchased merchandise as a customer exits a store. In other implementations, reader 130 may include other types of wireless systems/interfaces, such as a near field communication (NFC) system/interface that is able to read NFC tags included with purchased merchandise. In each case, reader 130 may be able to “interrogate” a customer's purchases without requiring human intervention. For example, reader 130 may wirelessly read tags on merchandise when the merchandise is in relatively close proximity (e.g., 1 foot to 20 feet) of reader 130. The term “tag” as used herein should be construed to include any type of identification associated with merchandise that may be wirelessly read by reader 130.

Reader 130 may also receive information or request information from other devices in network 100. For example, reader 130 may request receipt information from user device 110 and/or PoS device 120. Reader 130 may include logic for determining whether a customer's receipt matches items exiting a store, as described in detail below.

Loss prevention server 140 may include one or more computer devices and/or servers responsible for communicating with other devices in network 100. For example, loss prevention server 140 may receive information from reader 130 and control other security-related devices and systems based on the received information. As one example, loss prevention server 140 may control a camera system to augment the security provided by reader 130, as described in detail below.

Network 150 may include one or more wired, wireless and/or optical networks that are capable of receiving and transmitting data, voice and/or video signals. For example, network 150 may include one or more public switched telephone networks (PSTNs) or other type of switched network. Network 150 may also include one or more wireless networks and may include a number of transmission towers for receiving wireless signals and forwarding the wireless signals toward the intended destination. Network 150 may further include one or more satellite networks, one or more packet switched networks, such as an Internet protocol (IP) based network, a local area network (LAN), a wide area network (WAN), a personal area network (PAN), a WiFi network, a Bluetooth network, an intranet, the Internet, or another type of network that is capable of transmitting data.

The exemplary configuration illustrated in FIG. 1 is provided for simplicity. It should be understood that a typical network may include more or fewer devices than illustrated in FIG. 1. For example, network 100, may include a large number (e.g., thousands) of user devices 110, as well as a large number (e.g., 10-100) of PoS devices 120, readers 130 and loss prevention servers 140. In addition, network 150 may include additional elements, such as switches, gateways, routers, etc., that aid in routing data. Further, network 100 may include a transaction server (not shown) that facilitates transactions between user device 110 and PoS device 120 and aids in providing electronic receipts to user device 110

In addition, various functions are described below as being performed by particular components in network 100. In other implementations, various functions described as being performed by one device may be performed by another device or multiple other devices, and/or various functions described as being performed by multiple devices may be combined and performed by a single device.

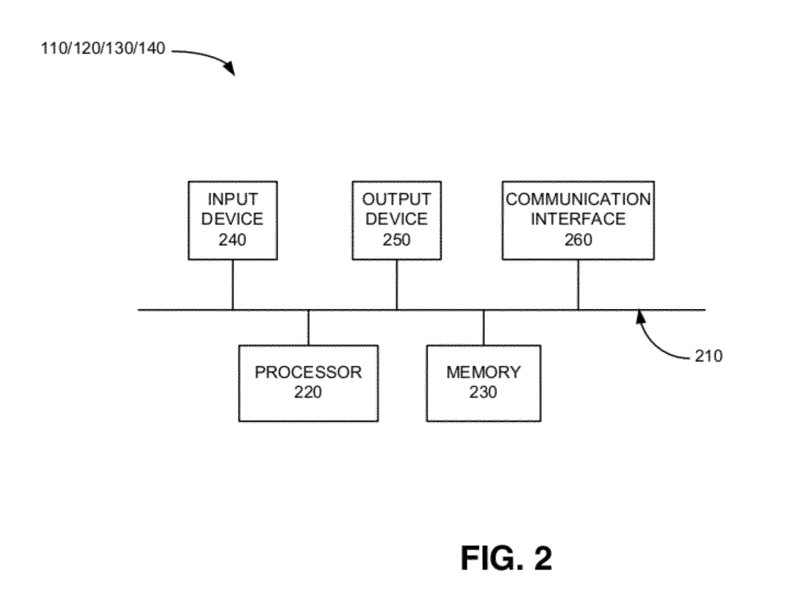

FIG. 2 illustrates an exemplary configuration of user device 110. Other devices in network 100, such as PoS device 120, reader 130 and loss prevention server 140 may be configured in a similar manner. Referring to FIG. 2, user device 110 may include bus 210, processor 220, memory 230, input device 240, output device 250 and communication interface 260. Bus 210 may include a path that permits communication among the elements of user device 110.

Processor 220 may include one or more processors, microprocessors, or processing logic that may interpret and execute instructions. Memory 230 may include a random access memory (RAM) or another type of dynamic storage device that may store information and instructions for execution by processor 220. Memory 230 may also include a read only memory (ROM) device or another type of static storage device that may store static information and instructions for use by processor 220. Memory 230 may further include a solid state drive (SDD). Memory 230 may also include a magnetic and/or optical recording medium (e.g., a hard disk) and its corresponding drive.

Input device 240 may include a mechanism that permits a user to input information to user device 110, such as a keyboard, a keypad, a mouse, a pen, a microphone, a touch screen, voice recognition and/or biometric mechanisms, etc. Output device 250 may include a mechanism that outputs information to the user, including a display (e.g., a liquid crystal display (LCD)), a printer, a speaker, etc. In some implementations, a touch screen display may act as both an input device and an output device.

Communication interface 260 may include one or more transceivers that user device 110 (or PoS device 120, reader 130, loss prevention server 140) uses to communicate with other devices via wired, wireless or optical mechanisms. For example, communication interface 260 may include one or more radio frequency (RF) transmitters, receivers and/or transceivers and one or more antennas for transmitting and receiving RF data via network 150. Communication interface 260 may also include a modem or an Ethernet interface to a LAN or other mechanisms for communicating with elements in a network, such as network 150 or another network.

In an exemplary implementation, communication interface 260 of reader 130 may include a radio frequency identification (RFID) system or interface for reading RFID tags/labels attached to items/merchandise. Alternatively, or additionally, communication interface 260 may include a near field communications (NFC) system/interface that allows reader 130 to read NFC tags attached to items/merchandise. For example, an NFC system/interface in reader 130 may include a short range, high frequency system that enables the short range exchange of data with another device (e.g., items with NFC tags).

The exemplary configuration illustrated in FIG. 2 is provided for simplicity. It should be understood that user device 110, PoS device 120, reader 130 and loss prevention server 140 may include more or fewer devices than illustrated in FIG. 2. In an exemplary implementation, user device 110 (or PoS device 120, reader 130 and loss prevention server 140) perform operations in response to processor 220 executing sequences of instructions contained in a computer-readable medium, such as memory 230. A computer-readable medium may be defined as a physical or logical memory device. The software instructions may be read into memory 230 from another computer-readable medium (e.g., a hard disk drive (HDD), SSD, etc.), or from another device via communication interface 260. Alternatively, hard-wired circuitry may be used in place of or in combination with software instructions to implement processes consistent with the implementations described herein. Thus, implementations described herein are not limited to any specific combination of hardware circuitry and software.

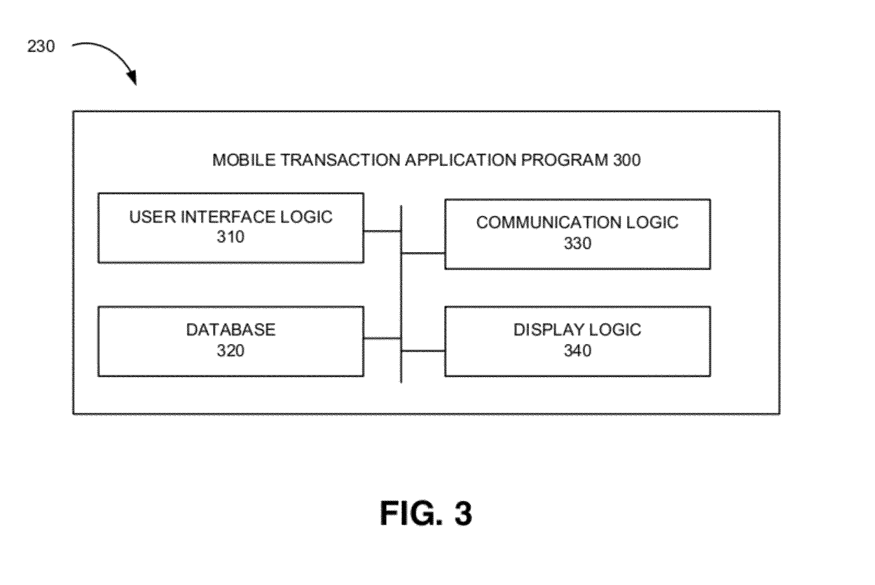

FIG. 3 is an exemplary functional block diagram of components implemented in user device 110 of FIG. 2. In an exemplary implementation, all or some of the components illustrated in FIG. 3 may be stored in memory 230. For example, referring to FIG. 3, memory 230 may include mobile transaction application (MTA) program 300. MTA program 300 may include software instructions executed by processor 220 that allows a party associated with user device 110 to manage receipts issued by various parties.

MTA program 300 may include user interface logic 310, database 320, communication logic 330 and display logic 340. MTA program 300 and its various logic components are shown in FIG. 3 as being included in user device 110. In alternative implementations, these components or a portion of these components may be located externally with respect to user device 110.

User interface logic 310 may include logic to facilitate entry of information associated with managing receipts. For example, user interface logic 310 may include a graphical user interface (GUI) that allows a user to easily enter information to request how his/her receipts will be electronically stored and organized.

Database 320 may store a user's receipts. For example, database 320 may store receipts in accordance with information provided by the user via user interface logic 310. As an example, database 320 may store receipts in accordance with information provided via user interface logic 310, such as by category, store, chronological order, etc.

Communication logic 330 may include logic for communicating with other devices in network 100. For example, communication logic 330 may transmit and/or receive information to/from PoS device 120, reader 130 and/or loss prevention server 140 via wired or wireless mechanisms.

Display logic 340 may include logic to display information received from, for example, PoS device 120. In one exemplary implementation, display logic 340 may output information to output device 250, such as an LCD or another type of display. For example, in one implementation, display logic 340 may display a mobile transaction code (MTC) or other identifier particularly associated with user device 110. A retailer associated with PoS device 120 may scan the MTC or otherwise receive the MTC when a transaction/purchase is taking place. In addition, display logic 340 may output an electronic receipt and other information received from PoS device 120 and/or a transaction server after the transaction is completed.

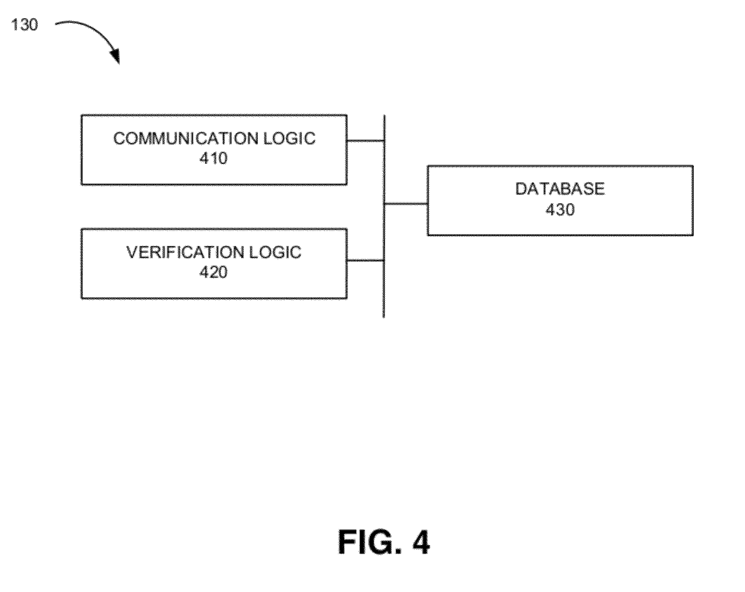

FIG. 4 illustrates an exemplary configuration of logic components implemented in reader 130. Referring to FIG. 4, reader 130 may include communication logic 410, verification logic 420 and database 430. It should be understood that reader 130 may include more or fewer logic devices than illustrated in FIG. 4.

Communication logic 410 may include logic that allows reader 130 to communicate with other devices in network 100 via network 150. For example, communication logic 410 may allow reader 130 to communicate wirelessly with user device 110, PoS device 120 and/or loss prevention server 140 via network 150. In one implementation, communication logic 410 may include an RFID interface, an NFC interface and/or another type of wireless interface for reading tags or labels included on items/merchandise.

Verification logic 420 may include logic for determining whether items that a customer is leaving a store/retail location with match items on the customer's receipt. For example, verification logic 420 may read RFID tags, NFC tags or other types of tags associated with merchandise. Verification logic 420 may also receive information from user device 110 corresponding to the customer's electronic receipt. Verification logic 420 may then compare the items to determine whether the customer is leaving with items that were not purchased, or whether the customer has left one or more items behind, as described in more detail below.

Database 430 may include one or more databases of information associated with electronic receipts. For example, database 430 may include a database of receipts associated with a large number of parties. As an example, database 430 may store electronic receipts provided to reader 130 by PoS device 120. Alternatively (or additionally), database 430 may receive electronic receipts from a number of user devices 110 via MTA programs 300 stored in user devices 110. Reader 130 may temporarily store these receipts in database 430. Verification logic 420 may access database 430 and compare items exiting or entering a retail location with items on a customer's receipt, as described in detail below.

In an exemplary implementation, communication logic 410, verification logic 420 and database 430 may include one or more processors, microprocessors or other processing logic/hardware, such as processor 220 (FIG. 2) used to interpret and execute instructions. In such implementations, the logic components may include software instructions stored in a computer-readable medium, such as memory 230. A computer-readable medium may be defined as one or more memory devices. The software instructions may be read into memory from another computer-readable medium or from another device via a communication interface. The software instructions contained in memory may cause the various logic components to perform processes that are described below. Alternatively, hardwired circuitry may be used in place of or in combination with software instructions to implement the logic processes consistent with the exemplary embodiments. Thus, systems and methods described herein are not limited to any specific combinations of hardware circuitry, firmware, and software.

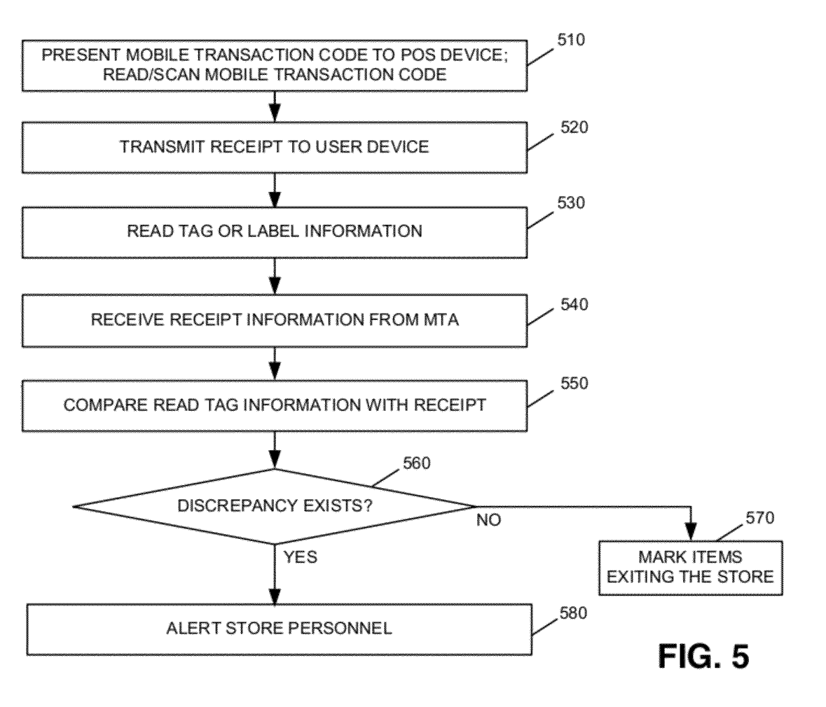

FIG. 5 is a flow diagram illustrating exemplary processing associated with verifying customer purchases in network 100. In this example, assume that the user associated with user device 110 (also referred to herein as the customer) would like to make a purchase at a retail location associated with PoS device 120. Processing may begin with the user launching MTA program 300 in user device 110 and making a purchase at PoS device 120. In this example, assume that the user of user device 110 presents the MTC associated with MTA program 300 to the clerk associated with PoS device 120 (block 510). In one implementation, the MTC may be in machine readable form, such as a barcode that is displayed on user device 110.

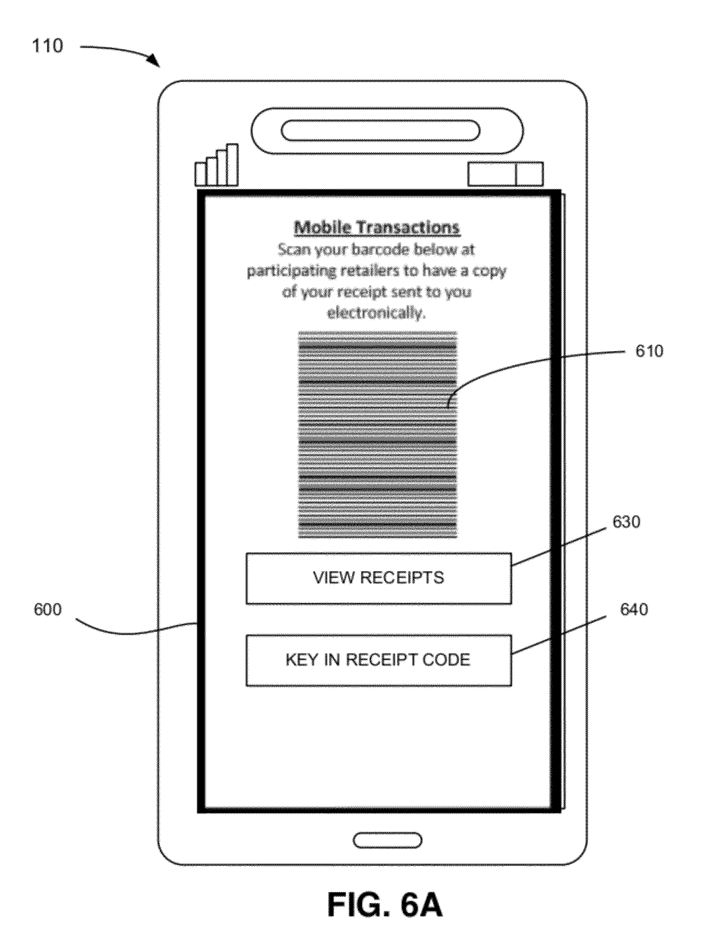

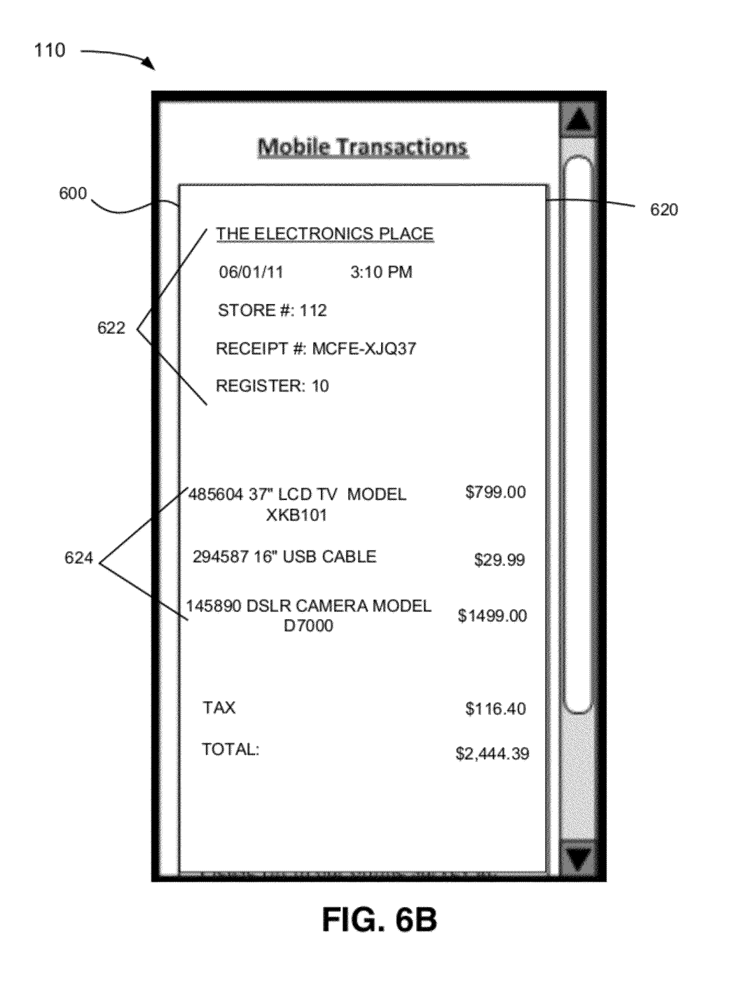

For example, FIG. 6A illustrates user device 110 in which output device 250 is a display screen 600, such as an LCD. Display 600 may provide barcode 610, which corresponds to the MTC associated with user device 110. Display 600 may also include a view receipts option 630 and a key in receipt code option 640. Options/input boxes 630 and 640 allow a user to retrieve previously stored receipts and search for a particular receipt. The customer associated with user device 110 may provide or present barcode 610 for reading/scanning at PoS device 120. Assume that a clerk at PoS device 120 scans barcode 610 using a scanner (block 510).

The MTC provided by user device 110 provides PoS device 120 with the customer's unique receipt service identifier (ID). For example, as discussed above, MTA program 300 may be assigned a unique service ID (i.e., MTC) that particularly identifies user device 110. This information may be used by other devices (e.g., reader 130 and loss prevention server 140) to identify parties associated with particular receipts and/or identify parties located near various tags read by reader 130.

As described above, PoS device 120 scans/receives the MTC at the time the transaction occurs (e.g., at any time before the transaction is completed) and transmits a copy of a detailed receipt, or a pre-receipt detail if payment has not been made by customer 110, to a transaction server (not shown). PoS device 120 may also send a unique transaction or receipt ID to the transaction sever, along with the detailed receipt. The receipt ID may later be used to identify a particular receipt. In some implementations, the detailed receipt sent by PoS device 120 may include a universal product code (UPC) or other unique product ID associated with each item that is being purchased. PoS device 120 may also transmit serial numbers associated with one or more of the items being purchased to the transaction server.

After the transaction is approved, MTA program 300 may automatically request a copy of the receipt from PoS device 120 and/or the transaction server (not shown) via network 150 (e.g., over cellular, WiFi, or other networks). In each case, PoS device 120 and/or a transaction server may transmit a receipt to user device 110 upon completion of the transaction (block 520). MTA program 300 may receive the electronic receipt, display the electronic receipt via output device 250 and/or store the receipt in database 320.

For example, FIG. 6B illustrates an exemplary electronic receipt 620 that may be provided on display 600 of user device 110. As illustrated in FIG. 6B, receipt 620 includes information at area 622 that is particular to the purchase, such as the name of the store (i.e., The Electronics Place in this example), the date, the store number, a receipt number and a register number. Receipt 620 also includes details of the purchase at area 624, such as the particular products purchased, cost, tax, total, etc. The products may be identified via a number or code that uniquely corresponds to the particular product and a name that identifies the product by brand and/or model.

In some implementations, the electronic receipt may include a higher level of detail and more information than the receipt initially displayed to the customer, such as the displayed receipt 620 illustrated in FIG. 6B. For example, if user device 110 is associated with only one account, there may be no need to display the customer's identification information via display 600. In addition, serial numbers of purchased products and other item specific information and details may not be provided via the initial default display of a receipt. However, such details may be available via user device 110 via interaction with user interface logic 310 of MTA program 300 to select other views or display options associated with electronic receipts.

After the transaction has been completed, assume that the customer begins leaving the store with his/her purchased goods. At or near the exit to the store, reader 130 may read each electronic tag or label associated with the customer's purchased products (block 530). For example, verification logic 420 (via communication logic 410) may read RFID tags located within a certain proximity of reader 130 (e.g., 1 to 20 feet). Verification logic 420 may temporarily store this information in database 430.

Verification logic 420 may also communicate with MTA program 300 of the user device 110 located in close proximity to the purchased products having the RFID tags to request a copy of the customer's electronic receipt. For example, verification logic 420 may send a query to the user device located closest to the items exiting the store. Assume that user device 110 receives the request and communication logic 330 of MTA program 300 transmits his/her electronic receipt associated with the purchase to reader 130. Further assume that communication logic 410 of reader 130 receives the communication that includes the electronic receipt (block 540).

Verification logic 420 may then compare each tag or label that was read with each item listed on the customer's electronic receipt (block 550). For example, the read tag information may include a product number or code that corresponds to the model number code on the electronic receipt (illustrated at area 624 in FIG. 6B). Verification logic 420 may then determine if a discrepancy exists between the items on the electronic receipt and the items exiting the store with the customer (block 560). In situations where serial numbers are available via the electronic tags, the serial numbers may be compared to the detailed information stored within the electronic receipts and/or store records to ensure that the correct merchandise/units are leaving the store and no substitutions have been made by the customer. If no discrepancy exists (i.e., all the read tag-related information corresponds to items on the electronic receipt), reader 130 may electronically store information in database 430 indicating that the customer has exited with all the products listed on the customer's receipt (block 570). For example, reader 130 may annotate or mark the receipt in database 430 to indicate the date and time in which the purchased products were removed from the store. This may prevent the customer from returning at a later time indicating that he/she did not receive certain products that he/she purchased.

If, however, one or more of the items that was read by reader 130 are not included on the customer's receipt, reader 130 may output an alert (block 580). The alert may be an audible and/or visual alert indicating that the customer may be leaving with products that he/she has not purchased. Store personnel may then approach the customer and verify that the customer is leaving with items he/she has not paid for.

Verification logic 420 may also determine if the customer is leaving the store without all of his/her purchases. For example, if verification logic 420 determines that one item on the customer's receipt did not correspond to information read by reader 130, verification logic 420 may provide an alert to store personnel indicating that the customer may have left one or more items at the checkout area. In addition, verification logic 420 may signal user device 110 and/or PoS device 120 to alert the customer and/or the checkout clerk that one or more items may have been left in the store. Alternatively, if the missing item was associated with an item that the customer brought into the store, rather than purchased at the store, verification logic 420 may account for that scenario, as described in more detail below.

In this manner, reader 130 may communicate with MTA program 300 to determine whether a customer is leaving with goods that he/she has not purchased, or if the customer has purchased goods that he/she has left behind in the store. This may allow a store to avoid unnecessary costs and delays associated with having security personnel check all customers as they exit the store.

As described above, reader 130 may read tags or labels included with items upon exit of a store and compare the read tags/labels with items on an electronic receipt. Reader 130 may also be used to track items when a customer enters a store, as described in detail below.

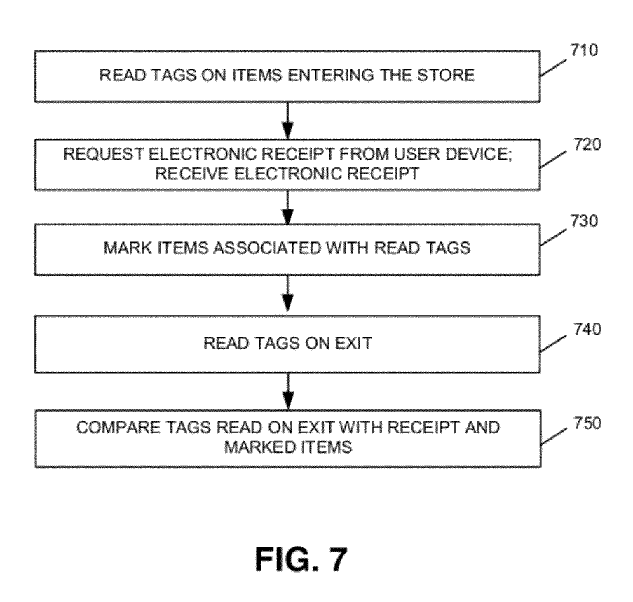

FIG. 7 is a flow diagram illustrating exemplary processing associated with tracking items/merchandise that a customer may bring into a store/retail location. In this example, assume that the customer would like to make a return or exchange an item that he/she purchased. Processing may begin with the user entering the store with a number of products that he/she previously purchased. In this scenario, readers 130 may be placed at an entrance to the store and may read the tags on the products entering the store (block 710). Reader 130 may also query a user device located in the vicinity of the entering products for an electronic receipt associated with the products entering the store (block 720).

For example, verification logic 420 may send a communication (via communication logic 410) querying MTA program 300 of user device 110 for a copy of one or more receipts associated with the particular store in which reader 130 is located. In an exemplary implementation, verification logic 420 may request the most recent receipt stored in MTA program 300 associated with the particular store/chain in which reader 130 is located. Assume that MTA program 300 provides reader 130 with the most recent receipt, which corresponds to the receipt associated with the item(s) being returned/exchanged (block 720).

Verification logic 420 may then mark items on the receipt that correspond to the read tags as items that are returning to the store (block 730). Verification logic 420 may store this information in database 430.

Assume that the customer exchanges two items on the receipt with replacement items. That is, the customer exchanges two items with identical replacement items. Further assume that the customer does additional shopping and purchases three more items. As described above with respect to FIG. 5, user device 110 may receive an electronic receipt associated with the new purchases.

As the user exits the store, reader 130 reads the tags associated with the newly purchased items and the replacement items (block 740). Reader 130 may also receive the receipt associated with the customer's new purchases and compare the read tags with items on the electronic receipt (block 750). Reader 130 may also retrieve the previous receipt stored in database 430 that indicates that the customer entered the store with two items for return/exchange. Verification logic 420 may then determine that the three new items correspond to items on the electronic receipt and that the two additional items correspond to the exchanged/replacement items. That is, if the read tags include the same identification information number or code as the information on the stored receipt marked with information indicating that the customer brought the two items into the store, this indicates that the customer merely exchanged the items with new similar items, or the customer left with the same items he/she brought into the store. In this case, verification logic 420 may mark the customer's receipt to indicate that the customer left the store with all five items and store this information in database 430.

If, however, a discrepancy exits, store personnel may be alerted as described above with respect to FIG. 5. That is, if the exchanged information does not correspond to the information on the original receipt, or the newly purchased items are not on the customer's receipt, verification logic 420 may alert store personnel of a potential problem. In this manner, reader 130 may determine whether items that were brought into a store correspond to items that are exiting the store.

In some implementations, reader 130 and/or loss prevention server 140 may include additional logic/mechanisms to detect various fraud attempts, such as a replay attack in which a user attempts to bring in tags without the corresponding items/merchandise and then leave with items associated with the tags. For example, assume that a person enters the store with six large screen TV tags, without the TVs, and is planning to swap the tags with similar tags still attached to large screen TVs. In this case, if reader 130 reads tags associated with high value items entering the store (e.g., items having greater than a predetermined value, such as $50, $100, etc.), verification logic 420 may signal loss prevention server 140 to capture multiple camera views of the customer entering the store to capture images that may be recorded. These images may then be used by personnel at customer service, checkout or exit when the user/MTA program 300 associated with the user that was identified on entry challenge (i.e., identified as having tags associated with items greater than a predetermined value) is later identified at these other points. This may allow personnel to make sure that the party is not leaving the store with items that he/she has not purchased. Similarly, in some implementations, verification logic 420 may signal loss prevention server 140 to capture images of a customer exiting the store with tagged items that exceed a predetermined monetary value. This may allow personnel to later view images of the customer (as he/she exited the store) to potentially dispute the customer if he/she later comes back to the store claiming that he/she left a purchased item in the store.

In other instances, when reader 130 identifies tags associated with items greater than a predetermined value as entering the store (or exiting the store), reader 130 may signal loss prevention server 140. Loss prevention server 140 may then signal greeters located near the store entrance/at computer terminals to notify the greeters of items supposedly brought into the store by an incoming customer. The greeters may then be able to visually confirm/deny presence of items associated with an individual identified by entry challenge at entry sensors/reader 130. Again, this may allow personnel to ensure that the party is not attempting to later leave the store with items that he/she has not purchased.

In some implementations, readers 130 may be used within the store to further control potential theft and/or monitor inventory. For example, in one implementation, shopping carts (which may be shielded to ensure that they only report cart contents, optionally using multiple sensors to detect items located between sensors) may contain readers (e.g., NFC readers, RFID readers, etc.) to detect what is placed in or removed from a cart. The readers 130 in the carts may transmit information regarding the contents of the cart to other store systems, such as a real time inventory system, PoS devices 120 in the store, exit scanners/readers 130, loss prevention server 140, etc. Readers 130 located at the exit to the store may then flag or identify items that may have been removed from the cart and placed in, for example, the customer's pocket or hand bag.

In addition, readers 130 placed at various strategic points within the store may help identify MTA programs 300 associated with various user devices 110 to associate with tracked items that can no longer be tracked (e.g., go “off the grid”). As an example, a clothing store may include a network of sensors located around the store. Tags or labels associated with the clothing may be read by the various sensors and matched to user devices 110 (that include MTA programs 300) that are travelling in close proximity to the tags. In this manner, if a customer takes a number of items into the dressing room and some tags go silent (e.g., are not detectable, the signal strength is less than a threshold level, etc.) before, during or after the customer enters the dressing room, reader 130 and/or loss prevention server 140 may identify an MTA program 300 in a particular user device 110 that was located near the one or more tags at or near time that the tag stopped responding/was no longer detectable. As discussed previously, each MTA program 300 may include a unique MTC associated with the particular user or user device 110. Therefore, the readers/sensors 130 and/or loss prevention server 140 may be able to uniquely identify a party associated with each MTA program 300.

Sensors associated with loss prevention server 140 may also pinpoint the user associated with the MTA program 300 that exhibits suspicious activity for automatic tracking via security cameras. Loss prevention server 140 may also flag the suspicious user at checkout/exit for additional scrutiny, such as closely checking the customer's purchases. In addition, loss prevention server 140 may optionally provide to PoS device 120 information identifying particular items or display images of missing items to assist checkout personnel to spot items that a party may be attempting to smuggle out of the store.

In some implementations, devices that do not run MTA program 300 may be used in conjunction with a user device that does include MTA program 300. For example, MTA program 300 may allow a user to assign some rights or link other devices to user device 110 running MTA program 300. As an example, a user may provide a printed barcode or other identifier to assign secondary rights to a device other than user device 110. In this case, if the secondary device (e.g., a music or game-playing device) includes the printed barcode/identifier, reader 130 may scan the barcode and the party may be allowed to exit the store with the merchandise. In still other implementations, a customer's loyalty card may include barcode/identifier and a secondary user may use take the primary user/customer's loyalty card into the store and reader 130 may scan the loyalty card to allow the person to exit the store with the merchandise.

As another example, assume that the customer associated with use device 110 has just exited a hardware store with one load of lumber of an order that includes several loads/carts of lumber. Further assume that the customer sends his/her child back into the store to retrieve a second cart filled with lumber. In this case, reader 130 at the exit may query a transaction server (not shown in FIG. 1) to determine if MTA program 300 has designated a secondary device (i.e., the child's MP3 player or cell phone) as being associated with the primary device (i.e., user device 110) based on the user profile. If so, the transaction server may provide approval to reader 130 to allow the user's child to remove the second cart of lumber from the store without setting off an alarm. Alternatively, loss prevention server 140 may query user device 110 with, for example, a text message in response to the child attempting to leave with a load of lumber. If the customer associated with user device 110 responds (e.g., via a text message) indicating that the other party (i.e., the customer's child in this example) is authorized to remove the items from the store, reader 130 may allow the user to leave the store with the lumber without setting off an alarm.

In still other implementations, labels or tags (e.g., NFC or RFID stickers) that may be read by reader 130 may be attached to receipts or order pulling sheets associated with large customer orders. For example, suppose that a customer places a large online order from an office supply store (e.g., 100 boxes of paper, 500 pens, 250 file folders, etc.). In this case, as the order is being filled by store personnel, the store personnel may scan the items going into the cart and mark the items on the order pulling sheet. When the customer picks up the order, the entire order list may be scanned as an aggregate into the system. The user may simply scan the label or tag associated with the large order and determine whether each items on his/her list has been loaded in the cart, without having to re-scan each item. Alternatively, paper associated with a large order may have NFC tags, RFID tags or other electronic or machine-readable tags embedded per-page, or at regular intervals.

In each case, associated IDs may be queried against a transaction server that will track which items/IDs (with optional human-friendly names) were picked up while continuing the order fulfillment tracking process.

In some implementations, MTA program 300 may reside on a device with a barcode reader, a camera, a quick response (QR) code reader, an NFC reader, etc., or may be temporarily linked (e.g. via Bluetooth) to such a device. In this manner, a customer associated with user device 110 may simply display a QR code or other identifier when exiting a store. Reader 130 may then determine what items were purchased.

In still another implementation, MTA program 300 may link to a store's inventory systems to confirm presence of desired items and current stocking locations with optional floor plan overlay. As an example, assume that a user is shopping for a dress for his wife. MTA program 300 may be linked with a shopping application/list on user device 110 that provides a drop down menu that allows the customer to select who the dress is for. Assume that the customer selects “wife.” The shopping application may include a profile of the customer's wife that includes the wife's dress size. When the customer then enters the store, readers 130 in the store may provide information to MTA program 300 indicating that the store currently has three dresses in the wife's size. Reader 130 (or another system in the store) may optionally provide a map of the store to MTA program 300 illustrating a layout of the store and a location of the three dresses.

Similarly, MTA program 300 may interact with store inventory systems to provide guidance on locating correct sizes, desired flavors, allergy/diet-friendly options, etc. Such linkages may be included in a mobile transaction system included in the particular store, or located externally from the store, may be obtained from third party queries to various users/customers or via direct queries to user device 110 executing MTA program 300. Still further, a “gifting” option may be enabled such that family members/friends can see whether anyone else has obtained the item for a given person relatively recently (assuming all parties are part of a group, permissions permit this, item is on a wish list, etc.).

Still further, in some implementations, tags or barcodes may be placed on objects that do not normally carrying such identifiers. For example, suppose that a customer frequents a particular restaurant and makes a special order, such as “number 7 with no curry.” In this case, the restaurant may prepare the dish and also provide a sticker/label with an NFC/QR code, along with textual description (e.g., No. 7 with no curry). The restaurant may place the customer's order in a container and include the sticker/label on the container. At a later time, the user may scan or take a picture of the label associated with the special order. When re-ordering that dish, user device 110 may electronically provide the NFC/QR code information to the restaurant and the special order will be prepared. In a similar manner, other types of special orders (e.g. extra spicy, no mushrooms, customer dairy/peanut allergy, etc.) may be processed to ensure that the correct items are delivered and to streamline the re-order process.

Implementations described herein provide for loss prevention monitoring, while reducing human costs associated with performing the monitoring. As described above, retailers may ensure that a customer does not leave with items he/she has not purchased, while also ensuring that the customer does not leave a purchased item in the store. In addition, inventory may be tracked within the store as a customer shops to provide additional security-related monitoring.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, features have been described above with respect to reader 130 reading tags, such as RFID tags or NFC tags associated with merchandise. In other implementations, reader 130 may read, interrogate or sense other types of identification information attached to merchandise that identifies the particular merchandise.

In addition, in implementations described above, user device 110 executing MTA program 300 communicating electronic receipt information to reader 130. In some implementations, user device 110 may send the electronic receipt information to reader 130 via any wireless medium/protocol, such as a text message transmission, email, a cellular data call, etc. In some implementations, reader 130 may embed data in communications to user device 110 that instructs user device 110/MTA program as to the preferred type of communication between user device 100 and reader 130.

Further, in some implementations, an RFID-enabled cart may be used both to track items from an inventory and theft-deterrent perspective, as well as an aid to customers. For example, in some implementations, an RFID-enabled cart may provide a cost of each item in the cart and a running tally of all the items in the cart. In still other implementations, a customer with an RFID or NFC reader included on user device 110 may be able to locate a particular item (e.g., a pair of pants having a particular size, a specific DVD, etc.) from a large set/bin of items.

In addition, implementations described above refer to a user device 110 that includes MTA program 300 communicating with reader 130 at an entrance or exit to a store. In other implementations, a customer's electronic receipt may be linked to, for example, his/her store loyalty card. In this case, reader 130 may be able to read the customer loyalty card when the customer exits the store to retrieve the customer's electronic receipt. In this manner, if the customer leaves his/her user device 110 at home, an electronic receipt may still be provided and reader 130 may retrieve the necessary information as the customer exits the store to check his/her electronic receipt against the items the customer is carrying out of the store.

Further, while series of acts have been described with respect to FIGS. 5 and 7, the order of the acts may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A computer-implemented method, comprising:
reading tags associated with items that are leaving a store with a person;
receiving an electronic receipt associated with the person;
comparing the items that are leaving the store with information included in the electronic receipt; and
determining whether a discrepancy exists based on the comparing.

2. The computer-implemented method of claim 1, further comprising:
generating an alert when a discrepancy exists.

3. The computer-implemented method of claim 1, wherein the determining whether a discrepancy exists further comprises:
determining whether the person entered the store with at least one of the items that are leaving the store with the person.

4. The computer-implemented method of claim 3, wherein the determining whether the person entered the store with at least one item comprises:
reading tags associated with items brought into the store by the person.

5. The computer-implemented method of claim 4, wherein the determining whether a discrepancy exists further includes:
comparing the tags associated with items brought into the store by the person with the tags associated with items that are leaving the store with the person.

6. The computer-implemented method of claim 1, further comprising:
reading tags brought into the store or taken out of the store by a second person; and
determining whether a monetary value associated with items corresponding to the tags brought into the store or taken out of the store by the second person is greater than a predetermined amount.

7. The computer-implemented method of claim 6, further comprising at least one of:
alerting store personnel, in response to determining that the monetary value is greater than the predetermined amount, or
using one or more cameras to capture images of the second person entering or exiting the store in response to determining that the monetary value is greater than the predetermined amount.

8. The computer-implemented method of claim 1, further comprising:
requesting that a user device, associated with the person, provide the electronic receipt, and wherein the receiving an electronic receipt comprises:
receiving the electronic receipt from the user device in response to the request.

9. The computer-implemented method of claim 1, further comprising:
determining that the person left a purchased item in the store; and
at least one of alerting a user device associated with the person or a check out terminal associated with a transaction involving the purchased item that the purchased item was left in the store.

10. A system, comprising:
at least one device configured to:
read identification information associated with items that are leaving a store with a person;
receive an electronic receipt associated with the person;
compare the identification information with information included in the electronic receipt; and
determine whether a discrepancy exists based on the comparing.

11. The system of claim 10, wherein the at least one device is further configured to:
generate an alert when a discrepancy exists.

12. The system of claim 10, wherein when determining whether a discrepancy exists, the at least one device is configured to:
determine whether the person entered the store with at least one of the items that are leaving the store.

13. The system of claim 12, wherein the at least one logic device is further configured to:
read tags associated with items brought into the store by the person to determine whether the person entered the store with at least one of the items.

14. The system of claim 10, wherein the at least one logic device is further configured to:
read tags brought into the store by a second person;
determine whether a monetary value associated with items corresponding to the tags brought into the store by the second person is greater than a predetermined amount; and
at least one of:
alert store personnel, in response to determining that the monetary value is greater than the predetermined amount, or
use one or more cameras to capture images of the second person entering the store in response to determining that the monetary value is greater than the predetermined amount.

15. The system of claim 10, wherein the at least one logic device is further configured to:
determine that the person left a purchased item in the store based on the comparing; and
at least one of alert a user device associated with the person or a check out terminal associated with a transaction involving the purchased item that the purchased item was left in the store.

16. The system of claim 10, wherein the at least one device comprises a reader configured to read the identification information and receive the electronic receipt via a wireless medium.

17. The system of claim 10, wherein the at least one device comprises a reader configured to read the identification information using at least one of radio frequency identification or near field communications.

18. A computer-readable medium having stored thereon sequences of instructions which, when executed by at least one processor, cause the at least one processor to:
receive information identifying items leaving a retail location;
receive an electronic receipt associated with a user who is leaving the retail location with at least some of the identified items;
compare the identified items with the electronic receipt; and
determine whether a discrepancy exist based on the comparing.

19. The computer-readable medium of claim 18, further including instructions for causing the at least one processor to:
generate an alert when a discrepancy exists.

20. The computer-readable medium of 18, wherein when determining whether a discrepancy exists, the instructions cause the at least one processor to:
determine whether the person entered the store with at least one of the items that are leaving the store with the person.
